(19) United States
(12) Patent Application Publication
(10) Pub. No.: US 2026/0227888 A1
(43) Pub. Date: Aug. 6, 2026

(54) FORCE-SENSITIVE INPUT CONTROL AT CLIENT DEVICE

(71) Applicant: Lenovo Global Technology (United States) Inc., Morrisville, NC (US)

(72) Inventors: Mark Delaney, Morrisville, NC (US); Diana Gerli, Morrisville, NC (US); John C. Mese, Morrisville, NC (US); Nathan Peterson, Morrisville, NC (US); Matthew Dennis Kohut, Morrisville, NC (US)

(21) Appl. No.: 19/044,963

(22) Filed: Feb. 4, 2025

(51) Int. Cl. G06F 3/0484; G06F 3/01; G06F 3/041; G06N 3/02

(52) U.S. Cl. CPC G06F 3/0484; G06F 3/013; G06F 3/0414; G06N 3/02; G06F 2203/04105

(57) ABSTRACT

In one example, a laptop computer may include a pressure sensor in its housing, with the sensor disposed underneath a palm rest area of the housing. The laptop computer may also include a processor and storage. The storage may include instructions executable by the processor to receive input from the pressure sensor, and to incrementally control a function of the electronic device according to a magnitude of pressure indicated in the input. The function may be identified based on a context associated with the laptop computer, such as one associated with an active window of the laptop computer, one associated with an area of the laptop computer's display at which the user is identified as looking, and/or one associated with content presented on the display. If desired, an application executed at the laptop computer to perform these steps may be enabled by a remotely-located server in a software-as-a-service (SaaS) implementation.

### FIELD

The disclosure below relates to technically inventive, non-routine solutions that are necessarily rooted in computer technology and that produce concrete technical improvements. In particular, the disclosure below relates to force-sensitive input control at client devices.

### BACKGROUND

As recognized herein, laptop computers and other types of client devices have underutilized hardware space on their housings. With this in mind, the disclosure below recognizes that additional technological improvements can be realized to improve the functionality and ease of use of these devices.

### SUMMARY

Accordingly, in one aspect a laptop computer includes a housing, a display in the housing, and a first pressure sensor in the housing. The first pressure sensor is disposed underneath a palm rest area of the housing. The laptop computer also includes a processor system in the housing as well as storage in the housing. The storage is accessible to the processor system and includes instructions executable by the processor system. The instructions are executable to receive input from the first pressure sensor and to identify a context. The context is associated with an area of the display that is determined to be a focus of user attention (e.g., the context is associated with an active window and/or an area of the display at which a user is identified as looking). The instructions are also executable to, based on the input from the first pressure sensor and the identified context, control a function of the laptop computer.

In some example embodiments, the area of the display receiving user attention may be a graphical user interface of a software application, and the context may be associated with the software application. The context may then be used to identify one or more functions controllable through the graphical user interface

Also in some example embodiments, the storage may include further instructions that cause the processor system to receive biometric sensor data from which a looking direction of a user can be identified. Here, the area of the display determined to be the focus of user attention may be identified based on the looking direction of the user. If desired, the context may be a graphical control being presented at the area of the display determined to be the focus of user attention, the graphical control being manipulable to control the function.

Additionally, in some non-limiting implementations, the instructions may be executable to execute a trained model to infer the function to control based on the context. Here, the context may be related to content presented in a graphical user interface and/or content presented at the area of the display determined to be the focus of user attention. Also according to this example, the model may include one or more artificial neural networks.

Still further, in some example implementations the instructions may be executable to use the context to identify the function to control, and to control the identified function according to the input from the first pressure sensor. So in one particular instance, the input from the first pressure sensor may indicate a pressure amount, and here the instructions may be executable to control the identified function according to a magnitude of the pressure amount. For example, the instructions may be executable to control the identified function by incrementally progressing through the function at a speed that is based on the magnitude of the pressure amount. The function itself may be, but is not limited to, scroll up/down or left/right, zoom in/out, display brightness up/down, media playback speed up/down, and/or volume up/down.

What's more, in some example embodiments the laptop computer may include a second pressure sensor in the housing and underneath a second palm rest area of the housing. The second pressure sensor may be different from the first pressure sensor. Here, the instructions may be executable to control the function of the laptop computer in a first fashion based on the input from the first pressure sensor and the identified context. The instructions may also be executable to receive input from the second pressure sensor, and to control the function of the laptop computer in a second fashion opposite the first fashion based on the input from the second pressure sensor and the identified context.

In non-limiting examples, the first pressure sensor may include a force sensitive resistor.

In another aspect, a method includes receiving input from a pressure sensor under a depressable housing area of a device. The method also includes identifying a context associated with the device and, based on the input from the pressure sensor and the identified context, controlling a function of the device.

In one particular example, the receiving, identifying, and controlling steps may be executed as part of a software application (“app”) executable at the device. Here, the method might include activating, from a remotely-located server, the software app for use at the device.

Also in one example, the context itself may be identified from a graphical user interface, an area of a display of the device that is determined to be a focus of user attention, and/or content presented on the display.

Still further, in one non-limiting implementation, the method may include executing a model to identify the function to control based on the context. The model may include one or more artificial neural networks (ANNs).

In still another aspect, at least one computer readable storage medium (CRSM) that is not a transitory signal includes instructions that are executable by a processor system. The instructions are executable to receive input from a pressure sensor within a housing of an electronic device. The instructions are also executable to incrementally control a function of the electronic device according to a magnitude of pressure indicated in the input.

In one example embodiment, the instructions may also be executable to receive a communication from a server to enable control of the function at the electronic device based on inputs from the pressure sensor. Responsive to receipt of the communication, the instructions may be executable to enable control of the function at the electronic device based on inputs from the pressure sensor.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows a front perspective view of an example laptop computer consistent with present principles;

FIG. 3 shows a front cross-sectional view of the example laptop computer;

FIG. 4 shows an example chart that demonstrates control of a computer function through different amounts of force as sensed at a pressure sensor in the laptop computer consistent with present principles

FIG. 5 illustrates example logic in example flow chart format that may be executed by a device consistent with present principles;

FIG. 6 shows an example data table that may be used by the device to identify a function to control based on device context consistent with present principles; and

FIG. 7 shows an example graphical user interface (GUI) that may be presented on a display for an end-user to configure one or more settings of a client device or app to operate consistent with present principles.

### DETAILED DESCRIPTION

Among other things, the detailed description below discusses use of otherwise underutilized real estate on the C-cover of laptop computers and housings of other client devices, creating a unique interaction experience for users through force sensitive inputs. Present principles therefore set forth technical solutions to intelligently identify or otherwise leverage force sensitive inputs to control a device interface.

What's more, the disclosure below recognizes that using pressure sensors embedded within the device's housing may be made even more advantageous by locating the sensors under the palm rest areas of the laptop computer for intuitive, single-action control. Using pressure sensors at those locations may be distinguished over using LED displays and non-display touch-sensitive input surfaces like track pads at those locations. This is because LED displays might not be adequately viewable given the user's hand positions on the palm rest areas, while touch-sensitive input surfaces at those areas (display or trackpad) may cause many unintended commands and other false inputs to be issued to the device while the user types on the keyboard. Processing inputs from those types of devices might also be computationally heavier than processing input from force sensitive resistors under the wrist areas.

Thus, in employing present principles, a user can intentionally apply downward pressure to the palm rest areas to flex the C-cover housing inward at those areas. This may cause an inside side of the housing to make contact with the force-sensitive resistor inside the housing according to a pressure amount provided by the user. This enables quick, single-action, adaptive, and intuitive user interfacing between the laptop and user through differentiated pressure inputs, also helping to avoid unintentional or false inputs.

In one particular example, an artificial intelligence (AI) engine can be executed to recommend and enable inputs based on screen content. So if the screen content indicated media content, the AI engine may infer that media playback speed should be controlled through pressure inputs. If the screen content indicated a webpage from the Internet, the AI engine may infer that scroll up/down speed or screen reader up/down speed should be controlled through pressure inputs.

Thus, according to this example implementation, the laptop may scrape the display screen for, or otherwise identify, scaled user settings elements that are currently being presented on the display (such as volume, brightness, zoom or playback speed settings). Then once a scaled settings is detected for control, the corresponding function may be recommended to the user as the default setting when the on-screen content has high correlation to the function (default setting). What's more, tracking of mouse/cursor location and eye gaze location can be used to increase the model's confidence in an inferred function, particularly in multi-monitor applications. Recommendations for functions to execute can also be crowd sourced using the data of other users if deployed at an enterprise level and vetted through user adoption and acceptance.

Taking as an example media fast forward/rewind as the function to be executed based on current device context, if no force is sensed at either pressure sensor on the laptop, no action may be taken within the system. Then if 50% force is sensed at the right-side pressure sensor, media may be fast forwarded at 2× speed, whereas if 50% force is sensed at the left-side pressure sensor then the media may be rewound at 2× speed. If 100% force is sensed at the right-side pressure sensor, then media may be fast forwarded at 4× speed, whereas if 100% force is sensed at the left-side pressure sensor then media may be rewound at 4× speed.

Additionally, note that in some examples, present principles may be provided as part of a software-as-a-service (SaaS) operated by a computer manufacturer or third party. The SaaS provider may therefore own the service that recommends and activates the force sensitive input control at the client device. In one particular instance, all devices from the manufacturer might ship with the force-sensitive capability but the capability may not be enabled absent the appropriate subscription or license.

In any case, it may be appreciated that present principles enable dynamic single-action input to avoid multiple clicks and combo keystrokes, yielding better battery life and a differentiated user experience at the hardware and software levels at the same time.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C #or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

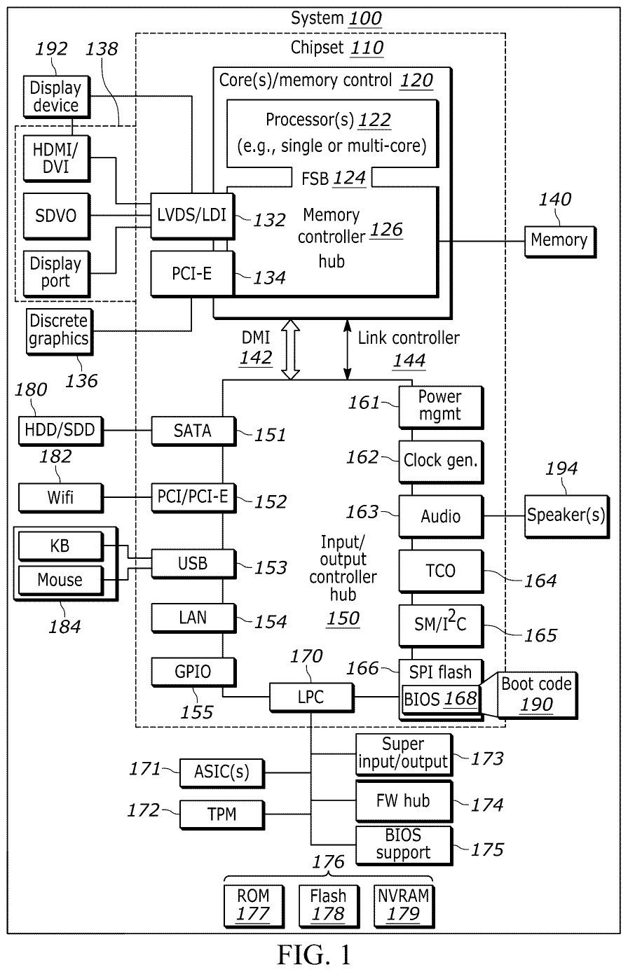

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

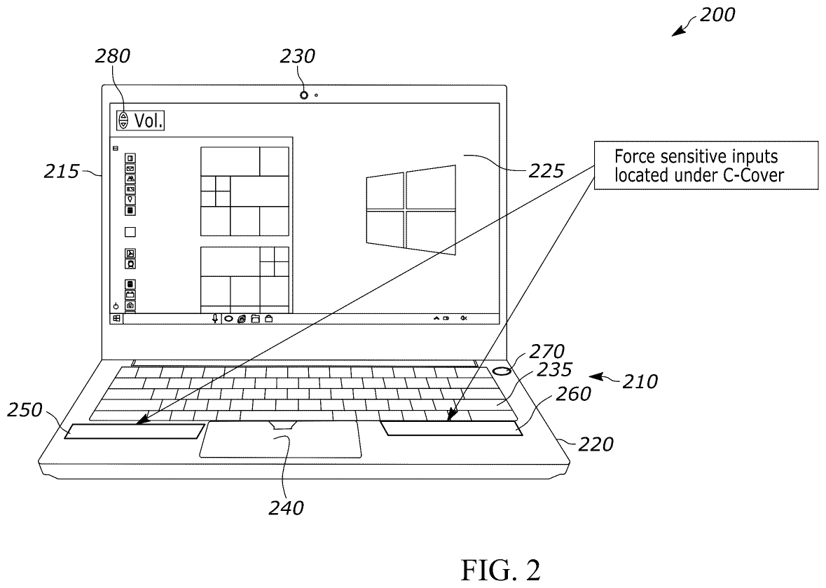

Now in reference to FIG. 2, a front perspective view is shown of an example laptop computer 200 consistent with present principles. The laptop computer 200 may include a housing 210 that defines an upper panel 215 and a lower panel 220 as shown. The housing 210 may be made of plastic, aluminum, and/or other suitable materials.

The upper panel 215 may include a touch-enabled electronic display 225 and a camera 230. The camera 230 may be a red green blue (RGB) camera and/or an infrared camera, either of which may be used for eye tracking consistent with present principles.

As also shown in FIG. 2, the lower panel's C-cover may include a keyboard 235 and non-display touch-enabled track pad 240. The lower panel 220 may also include other components of the laptop computer 200, including a central processing unit (CPU), memory, persistent storage, and other components discussed above in reference to FIG. 1.

Additionally, the computer 200 may include respective pressure sensors 300, 310 underneath first and second palm rest areas 250, 260 (underneath the C-cover). The areas 250, 260 themselves may therefore be located on the upper, outer surface of the second panel's housing 210.

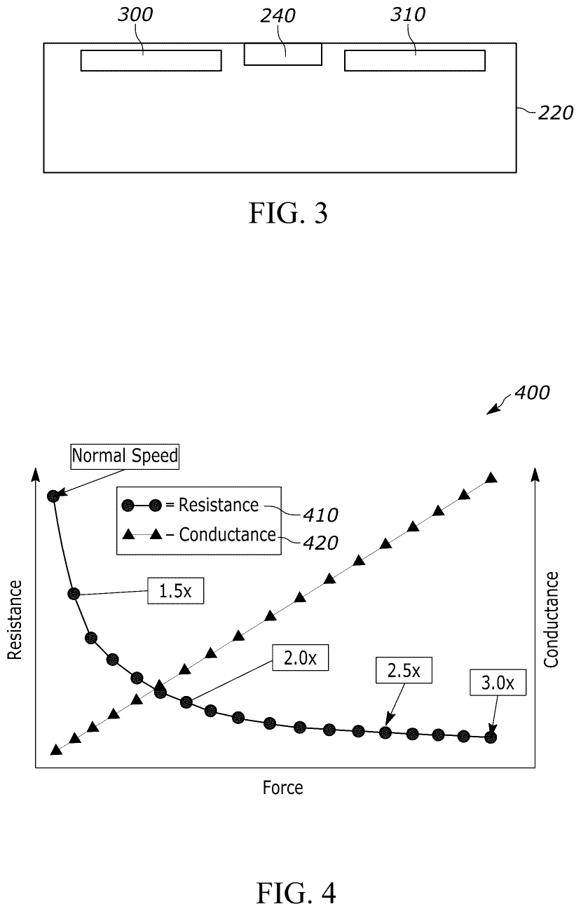

The sensors 300, 310 are shown in FIG. 3, which is a front cross-sectional view of the lower panel 220. Note that each sensor 300, 310 may be established by a force sensitive resistor or other suitable pressure/force sensor.

It may be appreciated from FIG. 3 that the touch-enabled touch pad 240 is located at the top of the panel 220 and is exposed to the elements for a user to provide touch input to the pad 240 while the laptop computer 200 is in the open configure shown in FIG. 2. But further note that the pressure sensors 300, 310 are not disposed with any portion thereof located at the outside surface of the second panel's housing. Rather, each sensor 300, 310 is located within the housing 210 beneath the palm rest areas 250, 260 such that the user's palms, while positioned to type on the keyboard 235, may exert a downward force on the palm rest areas 250, 260 to flex the housing 210 to contact the sensors 300, 310. This action provides user input to the sensors 300, 310 themselves. The palm rest areas 250, 260 may therefore be adjacent to the keyboard 235 and track pad 240 on the second panel's upper surface, distal to the keyboard relative to the hinge 270 of the laptop computer 200.

Thus, while the laptop computer's housing may be semi-rigid, it may still be flexible enough, at least at the areas 250, 260, to be depressable for an inside surface of the housing 210 to engage a sensor 300, 310 to provide the user input. In some examples, the portion of the housing bearing the areas 250, 260 may be modular and coupleable to other portions of the housing of the laptop computer 200 that are rigid. Additionally or alternatively, the portion of the housing bearing the areas 250, 260 may form part of a larger, unitary, and integral portion of the lower panel's housing.

Also note in relation to FIG. 2 that in some examples, when a certain function is identified as the function to execute based on input to the pressure sensors 300, 310, that function may be recommended to the user through the laptop computer 200 to let the user know what function is currently operative for pressure control. The recommendation may be provided through an audible voice or tone played on the laptop's speakers, or in the present example, may be presented graphically on the display via a graphical object (text or icon) indicating the operative function. FIG. 2 therefore shows a graphical object 280 indicating that the currently-operative function is volume up/down control.

Now in reference to FIG. 4, a chart 400 is shown to further demonstrate present principles related to the pressure sensors 300, 310. As shown, resistance is assigned to the left-side Y axis, conductance is assigned to the right-side Y axis, and force is shown along the X axis. It is to be understood that force sensitive resistors as might be used for the sensors 300, 310 may be variable resistors whose resistance decreases with applied force. They can thus act as a pressure-sensitive conductive material, where increased pressure brings conductive elements closer for increase conductance. It is to be further understood that a range of force can therefore be applied to control the resistor and hence control whatever function of the computer 200 is operative using that force.

Accordingly, it may be appreciated from the chart 400 shown in FIG. 4 that as force on the pressure sensor increases, resistance 410 at the sensor decreases and conductance 420 increases. The magnitude of the pressure amount sensed at the respective sensor may therefore be used, in the present example, to control playback speed of media being presented at the laptop computer 200. The media itself might be audio content such as a podcast or song sourced from an MP3 file, or audio/video content such as a video streamed over the Internet.

In any case, it may be appreciated that by the user pressing downward on the areas 250, 260 to apply a minimal amount of force of the inner surface of the housing 210 on the sensors 300, 310 themselves, the laptop computer 200 may be controlled to initiate or resume playback of the media at “normal” 1× speed. But should the user wish to increase the media playback speed to a speed faster than real-time, the user may increase the pressure he or she is applying to the areas 250, 260 to exert more pressure on the sensors 300, 310 themselves. This increase in magnitude of pressure may be sensed by the sensors 300, 310 and sent to the laptop's CPU or other processor that is controlling media playback for the processor to then incrementally increase playback speed. For example, playback speed may be increased to 1.5×, 2.0×, 2.5×, and 3.0× as also shown in FIG. 4.

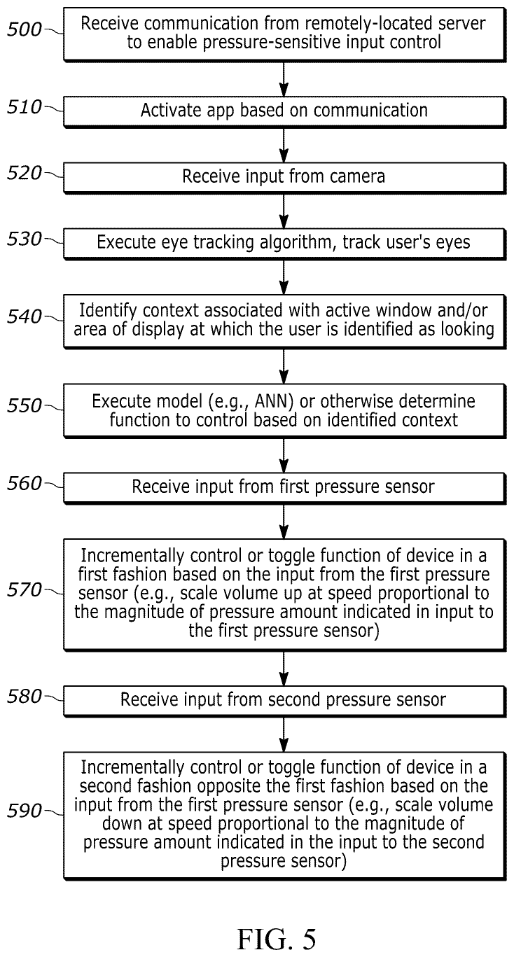

Continuing the detailed description in reference to FIG. 5, this figure shows example logic that may be executed by an apparatus established by a client device (e.g., laptop or smartphone) and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 5 is shown in flow chart format, other suitable logic may also be used (e.g., state machine).

Beginning at block 500, the client device may receive a communication from a remotely-located server to enable control of functions at the client device based on inputs from the client device's pressure sensor(s). The logic may then proceed to block 510 where, responsive to receipt of the communication, the apparatus may enable control of functions at the client device based on inputs from the client device's pressure sensor(s).

Thus, in one particular instance, receiving pressure sensor input, identifying a context associated with the client device, and controlling a function of the device based on the context (as described in greater detail below) may be executed as part of a software application (“app”) executable at the client device for the server to remotely activate the software app from the server for use at the client device. This might be done as part of a software-as-a-service (SaaS) operated by a computer manufacturer or third party.

From block 510 the logic may then proceed to block 520. At block 520 the apparatus may receive input from a camera on the client device, such as the camera 230 described above, and/or receive other biometric sensor data from which a looking direction of a user can be identified. The logic may then proceed to block 530. Here, the apparatus may execute one or more eye tracking algorithms using the input from the camera to track the user's eyes as appearing in the images from the camera 230 and determine an area of the client device's display that is the focus of user attention as identified based on the looking direction of the user (e.g., determine an area of the display at which the user is looking). Additionally or alternatively, the apparatus may also track cursor/pointer location on the display as controlled through a mouse or track pad to identify a relevant area of the display over which the cursor is hovering.

The logic may then proceed to block 540 where the apparatus may identify a context associated with an area of the display that is determined to be a focus of user attention. For example, at block 540 the apparatus may identify a context associated with an active (e.g., operative) window presented in the foreground on the client device's display and/or a context associated with another graphical user interface (GUI) of a software application. As another example, the apparatus may identify a context associated with the area of the display at which the user is identified as looking, and/or over which the on-screen cursor is hovering.

Also in addition to or in lieu of the foregoing, at block 540 the context may be identified from content presented on the client device's display. The content may be identified based on execution of a screen tracking and/or screen scraping algorithm on the content. Thus, in one particular example, this technique may be used to identify the context regardless of eye gaze location, cursor location, and/or active window.

However identified, the context itself may then be used to identify one or more functions controllable through the client device (e.g., through the active window or other GUI specifically when the active window/GUI is used to identify the context). The function might therefore be to turn volume up/down or to increase/decrease playback speed for an active window of a media player app.

Additionally or alternatively, the context may be used to identify one or more functions controllable through a graphical control that is presented at the area of the display determined to be the focus of user attention (e.g., an area at which the user is identified as looking). The graphical control itself may be manipulable to control the function. Thus, for example, the graphical control might be a volume up/down slider and scale combination, display brightness up and down buttons, display contrast up and down buttons, etc.

In one particular example, at block 550 the apparatus may even execute a model to infer the function to control based on the context, whether that be a context related to content presented in the active window, content presented at the area of the display at which the user is identified as looking/cursor hovering, or content presented on the display more generally. The context may thus be provided as input to the model for the model to infer the function. In some examples, other data may also be provided as input to the model along with the context, such as screen-scraped visual content and metadata about an app being executed to present the currently-active window (e.g., data indicating device functions controllable through the associated app/window itself). The model may include one or more artificial neural networks (NNs), such as one or more machine learning-based deep NNs configured for discriminating device functions to control based on context inputs and other input data. For instance, the one or more artificial NNs may be established by one or more feed-forward NNs and/or one or more convolutional NNs.

Accordingly, in one particular non-limiting example, the ML model may be configured to receive context data as input to then infer a function to control based on the context data. The ML model may be trained prior to deployment through supervised learning, unsupervised learning, reinforcement learning, and other machine learning techniques. In one particular example, the model may be trained using a dataset that includes different data pairs, with each pair including a context and other device-related data along with a respective ground truth function to execute.

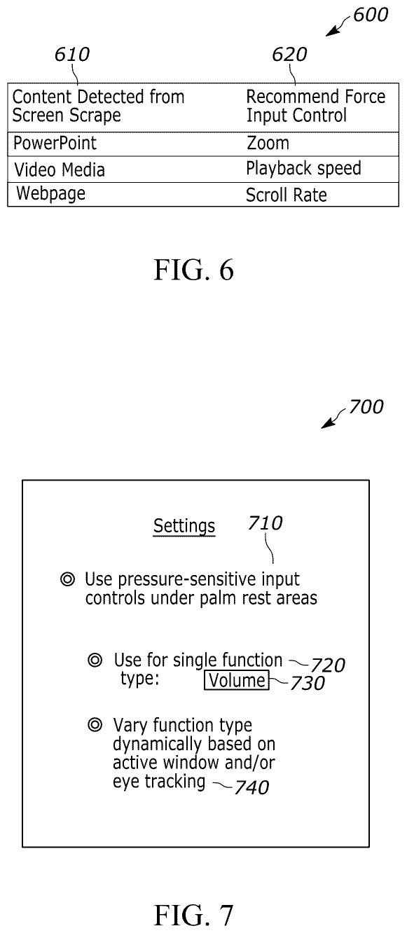

However, further note that other techniques may also be used for identifying a function to control based on the context, outside of executing an artificial intelligence (AI)-based model as described above. For example, FIG. 6 demonstrates that a rules-based algorithm may be executed to identify the function to control. Here, the apparatus of FIG. 5 may access a data table 600 or other relational database to correlate content detected from a screen scrape, active window, gaze location or hover location (per column 610) to a corresponding function to execute (per column 620).

Therefore, according to the present example, if a slide presentation is detected, table 600 indicates that a zoom in/out function may be determined as a recommended force input control given the context (slide presentation). Additionally, for the context of a video media player app being executed, table 600 indicates that a playback speed up/down function may be used as the function to control. In the context of a webpage being an active window or other currently-presented window, table 600 indicates that up/down or left/right scroll rate that is proportional to the magnitude of the pressure input may be used as the function to control.

Back to FIG. 5. At block 560 the apparatus may receive the aforementioned force sensor input if that input has not been received already. Therefore, in one example, one or more of steps 520-550 may be executed in advance of any force sensor input being received to have the associated function cached in memory (e.g., RAM) for instantaneous control responsive to receipt of the pressure sensor input itself. But in other examples, one or more of steps 520-550 may be executed responsive to the pressure sensor input to cut down on processor utilization and consume less power. In either case, note that the input received at block 560, according to the present example, is input from a first pressure sensor from among plural pressure sensors on the client device itself.

From block 560 the logic may then proceed to block 570. At block 570 the apparatus may control the identified function of the client device according to the input from the first pressure sensor. Thus, where the input from the first pressure sensor indicates a first pressure amount, the apparatus may control the identified function at a first speed according to the magnitude of the first pressure amount. Then if continued input from the first pressure sensor indicates a second pressure amount that is higher than the first amount, the apparatus may control the identified function at a second (faster) speed according to the higher magnitude of the second pressure amount.

Accordingly, in one example implementation, the apparatus might incrementally progress through the function at a speed that is proportional to the magnitude of whatever current pressure amount is indicated in the input from the first pressure sensor. For instance, increasing amounts of pressure to the first pressure sensor may command the client device to scroll up progressively faster, to zoom in progressively faster, to increase display brightness progressively faster, to increase media playback speed progressively faster, and/or to increase media playback volume level progressively faster.

Notwithstanding the foregoing, it is to be further understood that some functions that might be identified from the operative context may be binary functions, such as Wi-Fi on/off, Bluetooth on/off, etc. So according to these examples, at block 570 the device may toggle the associated function on/off, and might even do so at progressively faster intervals as pressure to the first pressure sensor increases.

From block 570, the logic of FIG. 5 may then proceed to block 580. At block 580 the apparatus may receive input from a second pressure sensor on the client device that is different from the first pressure sensor. The logic may then proceed to block 590 where the apparatus may control the identified function of the client device according to the second input from the second pressure sensor.

Note that if the context remains the same between blocks 570 and 590, the function that is controlled at block 590 may be the same function controlled at block 570 but with the function being controlled in opposite fashion. However, in examples where the apparatus continually monitors for current context associated with the client device, and the context changes between blocks 570 and 590, a different function of the device may be controlled using the second input from the second sensor based on the current context.

In any case, continuing with the examples provided for block 570 above, controlling the same function in the opposite fashion may include incrementally controlling the identified function oppositely but still at increasing speeds according to increasing magnitudes of pressure sensed at the second pressure sensor. Thus, pressure to the right-wrist area 260 as described above may be used to scroll up progressively faster (as sensed by the sensor 310), while pressure to the left-wrist area 250 as also described above may be used to scroll down progressively faster (as sensed by the sensor 300).

Likewise, pressure to the right-wrist area 260 may be used to zoom in progressively faster, while pressure to the left-wrist area 250 may be used to zoom out progressively faster. As another example, pressure to the right-wrist area 260 may be used to increase display brightness progressively faster, while pressure to the left-wrist area 250 may be used to decrease display brightness progressively faster. Or pressure to the right-wrist area 260 may be used to increase media playback speed progressively faster, while pressure to the left-wrist area 250 may be used to decrease media playback speed progressively faster. As but one more example, pressure to the right-wrist area 260 may be used to increase media playback volume progressively faster, while pressure to the left-wrist area 250 may be used to decrease media playback volume progressively faster.

What's more, it is to be further understood that controlling a function in opposite fashion as mentioned above may also be applied in the context of a binary on/off function or other toggle. Thus, pressure of any amount to the right-wrist area 260 may be used to toggle or turn the function on, while pressure of any amount to the left-wrist area 250 may be used to toggle or turn the function off.

Continuing the detailed description in reference to FIG. 7, this shows an example GUI 700 that may be presented on a display for an end-user to configure one or more settings of an apparatus or software application (“app”) to operate consistent with present principles. Each option discussed below may be selected by selecting the respective radio button adjacent to that option, whether through cursor input, touch input, or another type of input.

As shown, the GUI 700 may include a first option 710 that is selectable through a single user input to set or configure the device or app to undertake the actions described above in reference to FIGS. 2-6 for multiple future instances to thus control different device functions based on pressure amounts applied to under-housing pressure sensors.

The GUI 700 may also include a sub-option 720 that is selectable to set or configure the device/app to only control a single function type using pressure input to the pressure sensors. Different available functions may be selected by selecting the selector 730 (currently indicating volume as the operative function) to then cause a drop-down menu to be presented from which an available function may be selected.

Or if the user instead wanted the function controllable through pressure inputs to differ based on context as described above, the user may instead select sub-option 740 to set or configure the device/app to vary function type based on context.

Thus, input control of a given function can be manually programmed by the user through sub-option 720, or can be recommended by an AI model/engine based on user behaviors and on-screen inputs as discussed above through sub-option 730.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A laptop computer, comprising:
a housing;
a display in the housing;
a first pressure sensor in the housing, the first pressure sensor underneath a palm rest area of the housing;
a processor system in the housing; and
storage in the housing, the storage accessible to the processor system and comprising instructions executable by the processor system to:
receive input from the first pressure sensor;
identify a context associated with an area of the display that is determined to be a focus of user attention; and
based on the input from the first pressure sensor and the identified context, control a function of the laptop computer.

2. The laptop computer of claim 1, wherein the area of the display receiving user attention is a graphical user interface of a software application, and wherein the context is associated with the software application.

3. The laptop computer of claim 2, wherein the context is used to identify one or more functions controllable through the graphical user interface.

4. The laptop computer of claim 1, wherein the storage comprises further instructions that cause the processor system to receive biometric sensor data from which a looking direction of a user can be identified, and wherein the area of the display determined to be the focus of user attention is identified based on the looking direction of the user.

5. The laptop computer of claim 4, wherein the context is a graphical control being presented at the area of the display determined to be the focus of user attention, the graphical control being manipulable to control the function.

6. The laptop computer of claim 1, wherein the instructions are executable to:
execute a trained model to infer the function to control based on the context.

7. The laptop computer of claim 6, wherein the context is related to one or more of: content presented in a graphical user interface and/or content presented at the area of the display determined to be the focus of user attention.

8. The laptop computer of claim 6, wherein the model comprises one or more artificial neural networks.

9. The laptop computer of claim 1, wherein the instructions are executable to:
use the context to identify the function to control; and
control the identified function according to the input from the first pressure sensor.

10. The laptop computer of claim 9, wherein the input from the first pressure sensor indicates a pressure amount, and wherein the instructions are executable to:
control the identified function according to a magnitude of the pressure amount.

11. The laptop computer of claim 10, wherein the instructions are executable to:
control the identified function by incrementally progressing through the function at a speed that is based on the magnitude of the pressure amount.

12. The laptop computer of claim 11, wherein the function is selected from the group consisting of: scroll, zoom in/out, display brightness up/down, media playback speed up/down, volume up/down.

13. The laptop computer of claim 1, comprising a second pressure sensor in the housing and underneath a second palm rest area of the housing, the second pressure sensor being different from the first pressure sensor, wherein the instructions are executable to:
based on the input from the first pressure sensor and the identified context, control the function of the laptop computer in a first fashion;
receive input from the second pressure sensor; and
based on the input from the second pressure sensor and the identified context, control the function of the laptop computer in a second fashion opposite the first fashion.

14. The laptop computer of claim 1, wherein the first pressure sensor comprises a force sensitive resistor.

15. A method, comprising:
receiving input from a pressure sensor under a depressable housing area of a device;
identifying a context associated with the device; and
based on the input from the pressure sensor and the identified context, controlling a function of the device.

16. The method of claim 15, wherein the receiving, identifying, and controlling steps are executed as part of a software application (“app”) executable at the device, and wherein the method comprises:
activating, from a remotely-located server, the software app for use at the device.

17. The method of claim 15, wherein the context is identified from one or more of: a graphical user interface, an area of a display of the device that is determined to be a focus of user attention, content presented on the display.

18. The method of claim 15, comprising:
executing a model to identify the function to control based on the context, the model comprising an artificial neural network (ANN).

19. At least one computer readable storage medium (CRSM) that is not a transitory signal, the at least one CRSM comprising instructions executable by a processor system to:
receive input from a pressure sensor within a housing of an electronic device; and
incrementally control a function of the electronic device according to a magnitude of pressure indicated in the input.

20. The at least one CRSM of claim 19, wherein the instructions are executable to:
receive a communication from a server to enable control of the function at the electronic device based on inputs from the pressure sensor; and
responsive to receipt of the communication, enable control of the function at the electronic device based on inputs from the pressure sensor.
